(19) United States
(12) Patent Application Publication
(10) Pub. No.: US 2018/0233009 A1
(43) Pub. Date: Aug. 16, 2018

(54) SECURITY SYSTEM USING UNMANNED AERIAL VEHICLES

(71) Applicant: Donald SPECTOR, New York, NY (US)

(72) Inventor: Donald SPECTOR, New York, NY (US)

(21) Appl. No.: 15/389,565

(22) Filed: Dec. 23, 2016

Related U.S. Application Data
(60) Provisional application No. 62/424,709, filed on Nov. 21, 2016.

(51) Int. Cl. G08B 13/196; B64C 39/02; G05D 1/00; G05D 1/12; G08B 15/00

(52) U.S. Cl. CPC G08B 13/19608; B64C 39/024; G05D 1/0094; B64C 2201/066; G08B 15/00; G05D 1/0038; G05D 1/12

(57) ABSTRACT

A security system utilizes at least one unmanned aerial vehicle (UAV) that is equipped with a video camera and a motion detector. The UAV is controlled remotely by a ground control station having a computer. When not in flight, the UAV is mounted on a docking station that has a battery charger for charging a battery in the UAV when the UAV is docked at the docking station. The UAV has a transmitter that transmits an alert signal to the ground control station when an intruder is detected via the video camera or motion detector. The ground control station is configured to deploy and control the UAV to follow the intruder upon receiving the signal from the UAV. The UAV is controlled by personnel at the ground control station, who can direct the flight path of the UAV based on the movements of the intruders.

### CROSS-REFERENCE TO RELATED APPLICATIONS

This application claims priority under 35 USC 1119(e) of U.S. Provisional Application Ser. No. 62/424,709 filed on Nov. 21, 2016, the disclosure of which is herein incorporated by reference.

### BACKGROUND OF THE INVENTION

### 1. Field of the Invention

This invention relates to a security system using unmanned aerial vehicles (UAVs) to track and disable an intruder. In particular the invention relates to a security system in which cameras and/or motion sensors in the UAVs are used to detect an intruder, whereby a transmitter in the UAV alerts a central monitoring station, which then can deploy the UAV remotely to follow and disable the intruder.

### 2. The Prior Art

Various ways of using UAVs for security have been discussed in the art. For example, US Patent Application Publication No. 2012/0210853 to Abershitz et al. discloses a security system that deploys UAVs in response to an infiltration signal from a perimeter. The UAVs are launched from a central station in response to the signal. This system may work for a large facility, but is cumbersome for an individual household.

### SUMMARY OF THE INVENTION

It is an object of the invention to provide a security system for personal use in which the UAVs are provided on-site and can immediately follow an intruder when the intruder is detected.

This object is accomplished by a security system comprising at least one unmanned aerial vehicle (UAV) that is equipped with a video camera and/or a motion detector. The UAV is controlled remotely by a ground control station having a computer. When not in flight, the UAV is mounted on a docking station that has a battery charger for charging a battery in the UAV when the UAV is docked a the docking station.

The UAV has a transmitter that transmits an alert signal to the ground control station when an intruder is detected via the video camera or motion detector. Movement detected by the camera or motion detector sends a signal through the transmitter that an alert situation taking place. The ground control station is configured to deploy and control the UAV to follow the intruder upon receiving the signal from the UAV. The UAV is controlled by personnel at the ground control station, who can direct the flight path of the UAV based on the movements of the intruders. The ground control station has a transmitter that communicates with the motor of the UAV to direct its flight path. The UAV can also be equipped with a speaker to transmit communications and commands from the ground control station to an intruder or homeowner. The video camera can also be equipped with a microphone so that the ground control can hear as well as see what is going on around the UAV.

In a preferred embodiment, the UAV is equipped with a weapon to disable an intruder. This weapon is deployed by the personnel at the ground control station via remote control. The weapon can be any suitable type, such as chemical, mechanical, light or heat based. For example the weapon could be pepper spray or mace. Alternatively the weapon could consist of bullets or knives if lethal force is necessary. The weapon could also consist of incendiary devices such as flaming objects or explosives.

There is a power control connected to the UAV to arm and disarm the UAV so that the UAV is not tracking regular occupants of the house. The power control can take many different forms, such as a switch on the UAV, a keypad on the docking station, a remote control or a voice control. Any suitable arming/disarming mechanism such as those used in home security systems could be used here.

The transmitter on the UAV can be configured to send video and audio feed from the video camera to the ground control station so that personnel at the ground control station can view the monitored area. Preferably, the UAV is equipped with a global positioning system (GPS) and the transmitter is equipped to send GPS coordinates of the UAV to the ground control station when the UAV is in flight.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a UAV in a docking station according to the invention;

FIG. 2 shows a block diagram of the security system according to the invention; and

FIG. 3 shows a view of the UAV pursuing an intruder and being controlled by the ground control station; and

FIG. 4 shows a view of an alternative version of the UAV.

### DETAILED DESCRIPTION OF THE PREFERRED EMBODIMENTS

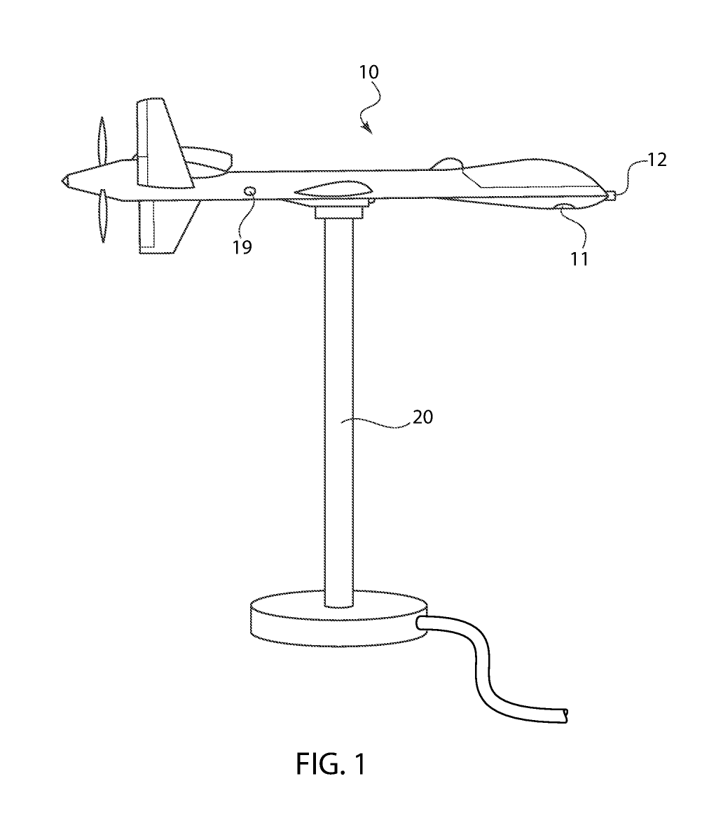

Referring now in detail to the drawings, FIG. 1 shows a

UAV 10 mounted on a charging stand 20, which can be connected to a power source (not shown). When not in use, the UAV can be continuously recharged by the charging stand. The UAV is equipped with a video camera 11 and a weapon 12 for firing ammunition such as bullets or pepper spray.

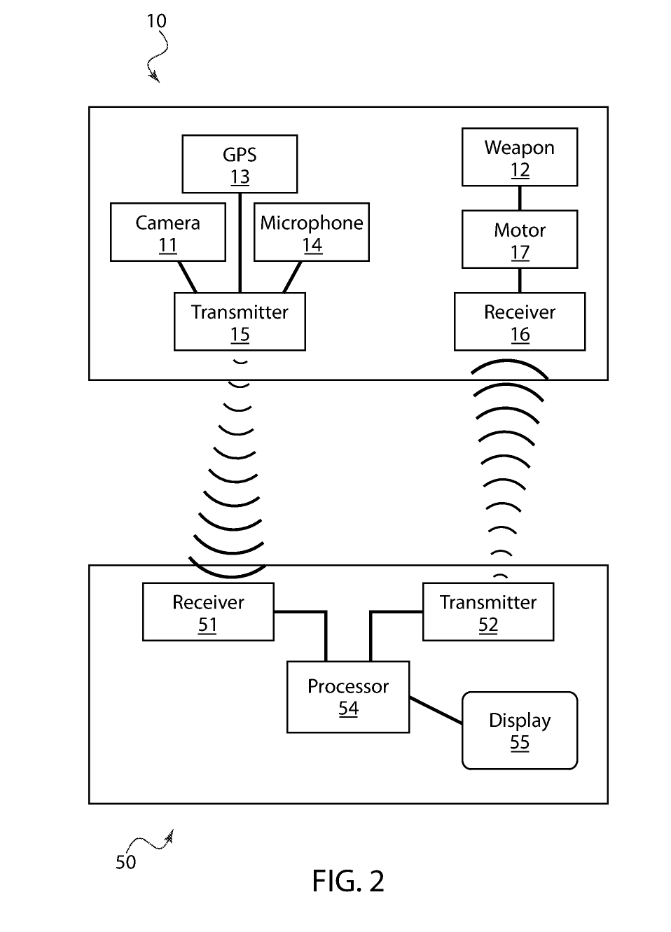

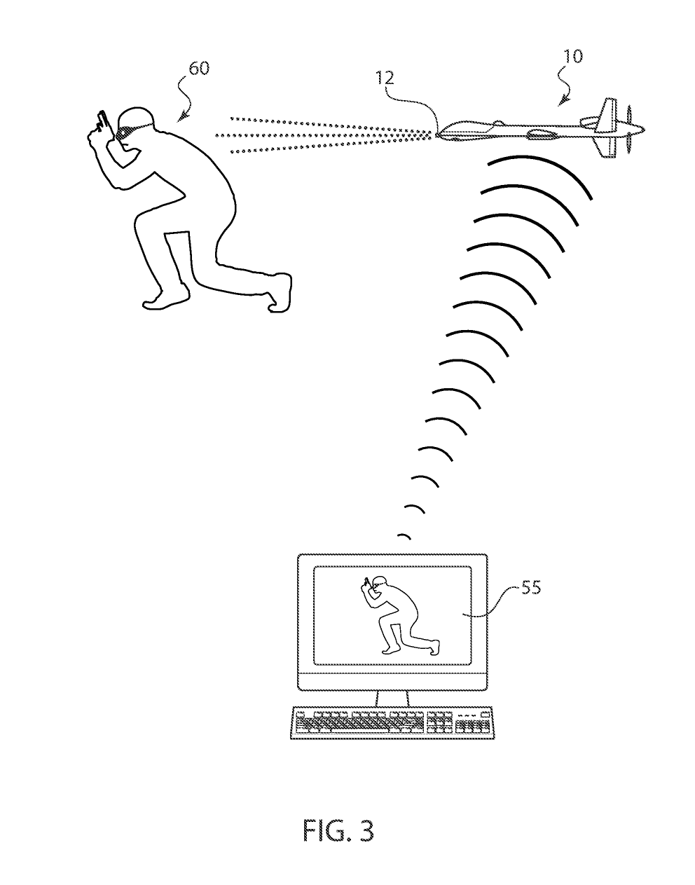

FIG. 2 shows a schematic diagram of the system according to the invention, in which UAV 10 communicates with and is controlled by ground control station 50. Control station 50 communicates with UAV 10 via a transmitter 15 and a receiver 16 in UAV 10 and a transmitter 52 and a receiver 51 in ground control station 50. The transmitters and receivers transmit data to each other via any suitable means, such as LTE, 4G, Wifi or other means. Connected to transmitter 15 in UAV 10 is the camera 11, a microphone 14 and a GPS sensor 13. Video feed from camera 11, sound from microphone 14 and position data from GPS sensor 13 are all continuously streamed through transmitter 15 to receiver 51. This information is then analyzed with a processor 54 in ground control station 50 and displayed in a readable fashion on display 55, as shown in FIG. 3.

Ground control station 20 also controls the movement and actions of the UAV 10 by transmitting commands through transmitter 52 to motor 17 of UAV 10. Thus, when personnel at ground control station 10 view an intruder on display 55, they can command UAV 10 to leave charging stand 20 and pursue the intruder 60, as shown in FIG. 3. The ground control personnel can also remotely activate the weapon 12 on UAV 10 so that UAV 10 can deploy the weapon 12 against the intruder 60. The weapon 12 can be configured to eject any desired ammunition, such as bullets, blades, pepper spray, mace, gas, etc. The UAV can also be equipped with a speaker to transmit communications from the ground control to the intruder or homeowner.

There is a control switch 19 on UAV 10 to allow the owner to arm and disarm UAV 10. When disarmed, UAV 10 does not communicate with ground control station 20 and cannot be deployed. When armed, video from camera 12 and sound from microphone 14 are streamed continuously to ground control station 20. Control switch 19 can be actuated manually or via remote control.

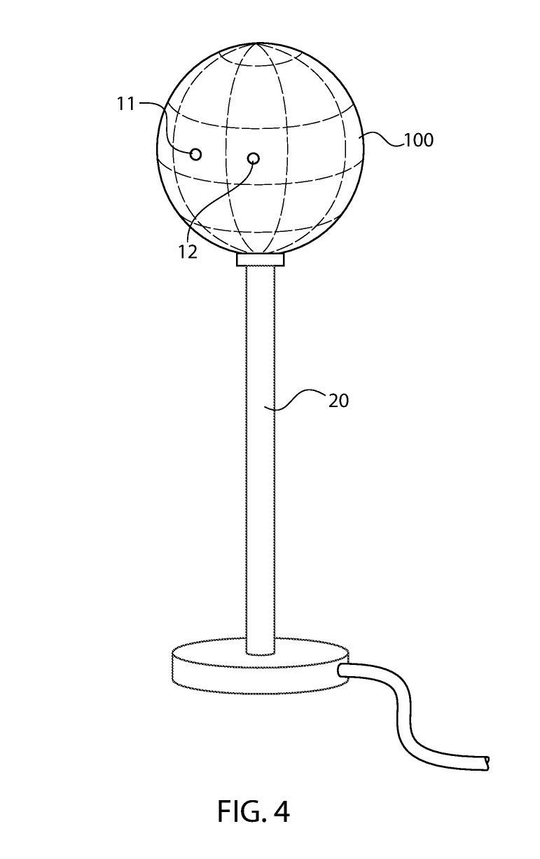

An alternative embodiment of the UAV is shown in FIG. 4.

Here, UAV 100 is configured as a sphere, having camera 12 and weapon 11 disposed therein. It operates in the same fashion as UAV 10. UAV 100 can be configured to be very small, so that UAV 100 itself could act as a weapon if flown fast enough into the target.

Accordingly, while only a few embodiments of the present invention have been shown and described, it is obvious that many changes and modifications may be made thereunto without departing from the spirit and scope of the invention.

What is claimed is:

1. A security system comprising:
at least one unmanned aerial vehicle (UAV), the UAV being equipped with at least one of a video camera and motion detector;
a ground control station having a computer configured for controlling the UAV remotely,
a docking station for supporting the UAV when not in flight, the docking station having a battery charger for charging a battery in the UAV when the UAV is docked a the docking station;
wherein the UAV has a transmitter that transmits an alert signal to the ground control station when an intruder is detected via the video camera or motion detector and wherein the ground control station is configured to deploy and control the UAV to follow the intruder.

2. The security system according to claim 1, wherein the UAV is equipped a weapon to disable an intruder, and wherein the ground control station is configured to deploy the weapon.

3. The security system according to claim 2, wherein the weapon is selected from the group consisting of pepper spray, mace, bullets and blades.

4. The security system according to claim 1, further comprising a power control connected to the UAV to arm and disarm the UAV.

5. The security system according to claim 4, wherein the power control can be remotely controlled.

6. The security system according to claim 1, wherein the power control is a voice-activated system.

7. The security system according to claim 1, wherein the transmitter is configured to send feed from the video camera to the ground control station.

8. The security system according to claim 1, wherein the UAV is equipped with a global positioning system (GPS) and wherein the transmitter is equipped to send GPS coordinates of the UAV to the ground control station when the UAV is in flight.

9. The security system according to claim 1, wherein the UAV is configured as a sphere.

10. The security system according to claim 1, wherein the UAV has a speaker and wherein the ground control station is configured to transmit communications through the speaker.
